(19) United States
(12) Patent Application Publication
(10) Pub. No.: US 2005/0201748 A1
(43) Pub. Date: Sep. 15, 2005

(54) Package for solid photographic-processing agent

(75) Inventor: Tomoyoshi Hyodo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/074,057

(22) Filed: Mar. 8, 2005

(30) Foreign Application Priority Data
Mar. 9, 2004 (JP) P.2004-065343

(51) Int. Cl. G03D 3/02

(52) U.S. Cl. 396/626

(57) ABSTRACT

A package for solid photographic-processing agent which is constructed such that a solid photographic-processing agent is housed in a prism-like container having at a top thereof an opening section, wherein (1) a surface resistivity of the inner surface of the container is less than or equal to 10¹² Ω, or (2) a material of the container is a laminated material comprising a plurality of layers containing at least a conductive aluminum metal thin layer.

### BACKGROUND OF THE INVENTION

1. Technical Field of the Invention

The present invention relates to a package in which a solid photographic-processing agent is housed. The invention also relates to a package which can be used for a method and a device for easily dispensing, out of a container, a solid photographic-processing agent without an operator touching the agent; preparing a processing solution; and further processing a photosensitive material.

2. Description of the Related Art

Processing of a photosensitive material is generally performed through processes of sequentially soaking the photosensitive material in a plurality of processing tanks, such as a color development tank and a bleach-fixing tank. Processing solutions in the respective tanks are deteriorated by the effects of other processing solutions, and the like, which are brought into the solutions together with the photo-sensitive material from the preceding process. Therefore, replenishers are added to the respective tanks in accordance with a processed amount of the photosensitive materials or the like. The replenisher is prepared from a photographic-processing agent.

When a photographic-processing agent is liquid, constituent chemicals are prone to problems, such as deterioration or crystallization, due to fluctuation in temperature. Furthermore, being of large weight and volume, a liquid photographic-processing agent is inconvenient in terms of storage space and handling. In addition, packaging materials such as a plastic bottle or plastic bag have been used for photographic-processing agents, and curtailing use of such packaging materials has been desired. For the above reasons, as compared with liquid photographic-processing agents, solid photographic-processing agents such as those of tablet or granular form have come into wider use. When a photographic-processing agent is solidified, simple packages can be used, which also brings about cost advantages. In view of the above, JP-A-4-338943discloses a gable-top type container which is appropriate for housing solid photographic-processing agents.

Meanwhile, when, for the purpose of assuring operational safety and labor-saving, an automatic solution preparation (processing solution preparation) device is employed in the course of preparation of a processing solution from a photographic-processing agent, an operator can prepare the processing solution without touching chemicals. In this case, it is also advantageous to employ an automatic solution preparation device whose application object is a package, in which a solid processing material is housed in a packaging material that can be mechanically opened. Furthermore, there has been disclosed a development equipment which incorporates such an automatic solution preparation-and-replenishment mechanism for solid processing agent housed in such an automatically-opened-type container, or a development equipment in which a solid replenishment agent is dispensed directly into a processing tank (e.g., JP-A-2003-307825).

Such a solid processing agent, as well as an automatic solution preparation device, a development equipment, and the like, making use of the solid processing agent, brings many advantages, including reduction in volume of processing agents, curtailment of usage of packaging materials, eased restrictions on mechanical strength on packaging materials, and reduction in air oxidation of processing agents caused by solidification. However, a development equipment of this type adapts a method in which a package is attached in an inverted state, thereby dispensing a solid processing material out of a packaging material into a preparation tank or directly into a processing tank. Accordingly, although the entire processing agent housed in a container must be dispensed rapidly, there often arises a problem that the processing agent adheres to the inside of the container, or is trapped between crimps of the container and the like, thereby remaining inside the container without being discharged. When the processing agent remains inside the container, component compositions of the photographic-processing solution prepared therefrom become inaccurate, and the effects thereof are accumulated during long-term continuous operation. Consequently, quality of a resultant photograph will be deteriorated.

In addition, when a solid processing agent remains adhering to a package, the package cannot be thrown away as is, and must be cleaned. Therefore, immediate improvement has been desired against chemical residues inside a packaging material, in view of occurrence of changes in components of a prepared processing agent as well as requiring excessive load to clarify waste solution.

Furthermore, in such an inverted dispensing method of the processing agent, desire has arisen for more simple and rapid opening of a package and dispensing of a processing agent, avoidance of touching chemicals in the course of opening and dispensing, prevention of powders becoming airborne in a case of a powder processing agent, and the like.

JP-UM-A-5-90494 discloses a method for smoothly removing a solid processing agent from a package, wherein a hook with a pull-string is disposed on a member forming a lip at an opening of a packaging material, and a package is unsealed by pulling the hook. However, rendering pulling strength uniform is difficult, as is discharging solid agent within a short period of time without allowing residues.

JP-A-2000-181044 discloses a package for housing a solid processing agent having a double structure consisting of an outer packaging material for mechanically protecting the package from the outside, and a barrier bag in which a solid agent is housed. The package is advantageous in terms of stability when being attached to a processing solution preparation tank in a highly humid working environment, or when being assembled into a development processor. However, the package is disadvantageous in the aspects of cost of packages and smoothness in handling in the course of opening.

JP-A-10-198016 discloses an opening-and-supply device, in which a seal section—which can be opened—is disposed at a top of a photographic-processing agent container, and which can be opened by pulling seal members in opposite directions. The container having a simple structure employed in JP-A-10-198016 has solved the drawback of the liquid processing agent; however, it has not yet sufficiently solved the above problem that the solid processing agent remains inside the container.

As described above, desire has existed for any one or a combination of an appropriate opening method, container, and photographic solid processing agent; and for smoothly discharging a solid processing agent housed in a simple package in a short period of time without allowing residues in a comparatively hot, humid environment as well as in a low-temperature, low humidity environment. The present invention has been conceived in view of such a background.

### SUMMARY OF THE INVENTION

The present invention aims at providing a solid processing agent package which is constructed to house a solid photographic-processing agent, and which enables easy mechanical discharge of a solid processing agent when, for instance, a package is opened in an inverted state to discharge the entire solid photographic-processing agent, regardless of whether the processing agent is in powder, granular, or tablet form, without leaving residues of the processing agent inside the container and without the processing agent being touched directly by an operator.

To achieve the object, the inventor has dedicated himself to analyzing the reason why, in a case where the content is a solid processing agent, the processing agent remains inside a gable-top-type paper packaging material, or a container of a so-called gusset pouch-type film packaging material, when the agent should easily drop and be discharged when the container is brought into an inverted state and opened. As a result, the inventor has found that an interrelationship exists between surface conductivity of the inner wall of the container and tendency of the agent to remain as residue. Further investigation thereof has led to the below-described invention.

(1) A package for solid photographic-processing agent which is constructed such that a solid photographic-processing agent is housed in a prism-like container having at a top thereof an opening section, wherein a surface resistivity of an inner surface of the container is less than or equal to 10¹² Ω.

(2) The solid photographic-processing agent package defined in (1), wherein the container is made of a single component material having a surface resistivity less than or equal to 10¹² Ω.

(3) The solid photographic-processing agent package defined in (1), wherein the component material of the container is a laminated material consisting of a plurality of layers; and a surface resistivity of a constituting layer forming the inner surface of the container is less than or equal to 10¹² Ω.

(4) A package for solid photographic-processing agent which is constructed such that a solid photographic-processing agent is housed in a prism-like container having at a top thereof an opening section, wherein a material of the container is a laminated material comprising a plurality of layers which contain at least a conductive aluminum metal thin layer.

(5) The solid photographic-processing agent package defined in (4), wherein an inner surface of the container has been treated with an antistatic agent.

The present invention is characterized in that the surface resistivity of the inner surface of the container of the solid processing agent package is set to less than or equal to 10¹² Ω. When such conductivity is imparted to the inner surface, in a case where the solid processing agent package is attached in an inverted state to an automatic processing solution preparation device or a development equipment, and an opening section at a lower portion of the container is opened to thus discharge the solid processing agent into a preparation tank or into a processing tank under the force of gravity, the entire quantity of the processing agent is discharged smoothly and in a short period of time. Accordingly, no residual processing agent is left inside the container.

In addition, in a case where the material of the container is a laminated material comprising a plurality of layers which contain at least a conductive aluminum metal thin layer, the above-described effect can be also obtained without limiting the surface resistivity to the above-described range. The conductive aluminum metal thin layer is preferably disposed to a side that has contact with the solid processing agent in the laminated material. However, in consideration of the prevention of the corrosion and the like, the conductive aluminum metal thin layer is preferably disposed to an inner side than the side that has contact with the solid processing agent.

Therefore, an empty container after discharge of the processing agent does not require cleaning, and can be reused, thereby eliminating workload of cleaning; and component compositions of thus-prepared processing solution are accurate and comply with the design, thereby ensuring quality of the processing solution. In addition, splashing of chemicals, contacting of chemicals with a skin, and contamination of equipment, which would otherwise result from dispensing of a processing agent, are prevented. Furthermore, there is also negated a need for eliminating static by means of introducing into the container air including charges generated by corona discharge.

For a container of the solid processing agent package, an arbitrary material, such as paper, plastic, metal, or a composite material thereof, is preferably employed, so long as the material satisfies the aforementioned requirement imposed on the surface resistivity of the inner surface.

More particularly, the container may be constructed of a single material, a laminated material consisting of a plurality of layers—particularly a laminated material including a conductive aluminum metal thin layer—or a material whose inner surface has been subjected to anti static treatment. The details thereof will be described later.

Employing the package for solid photographic-processing agent of the invention characterized in that the surface resistivity of the inner surface of a container which houses a solid photographic-processing agent is less than or equal to 10¹² Ω or in that a material of the container is a laminated material comprising a plurality of layers which contain a conductive aluminum metal thin layer allows, when the container is opened to discharge the solid photographic-processing agent, smooth discharge of the entire quantity of processing agent in a short period of time. Accordingly, no residual processing agent is left inside the container. Consequently, the component compositions are accurately maintained, and work of cleaning the container is negated.

### BRIEF DESCRIPTION OF THE DRAWINGS

FIG. 1 is a perspective view showing the configuration of a gable-top type container which can be preferably applied to the invention.

FIG. 2 is a schematic view showing a typical example in which a solid processing agent package is opened, and a solid processing agent is discharged out of a container.

### DETAILED DESCRIPTION OF THE INVENTION

[Solid Processing Agent Container]

A container for solid processing agent applicable to the invention may be an arbitrary container, so long as it satisfies the aforementioned requirement for the surface resistivity of the inner surface, and no restriction is imposed on its shape, size, material, and the like. However, effects of the invention are remarkably pronounced in a case where the container is used as a container for a solid photographic-processing agent package for the use of a development equipment or an automatic processing solution preparation device equipped with an automatic opening device. An embodiment to be described below employs such a structure that a solid processing agent is housed in a gable-top-type paper container or a gusset-pouch-type film container. Accordingly, the description will be provided while a gable-top-type container is taken as an example.

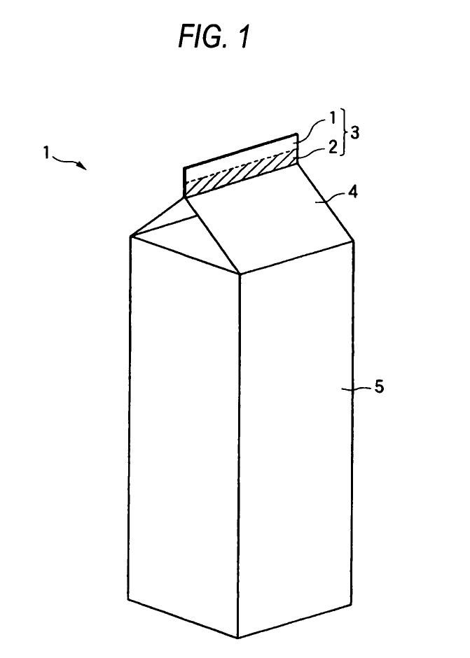

FIG. 1 is a perspective view showing the configuration of a gable-top-type container according to the invention. FIG. 1 shows that the gable-top-type container is formed from an opening section 3 constituting the top, a roof section 4 continuous with the opening section 3, and a prism-like container main body 5 adjacent to the roof section 4.

The opening section 3 is formed by extending the single sheet material common to the container main body 5 and the roof section 4. The opening section 3 comprises a seal section 2 adjacent to the roof section 4 which measures 3 to 20 mm in width, and pulling flaps 1 disposed on the top-most section of the container located further upward of the seal section 2. The pulling flaps 1 are disposed on the top of the container as a portion gripped by grips at a time of opening. The pair of pulling flaps 1, which are continuous with opposite faces of the container main body 5, contact each other but are not adhered to each other. Accordingly, a pair of grips can grip the pair of pulling flaps 1 individually. The pulling flaps 1 measure 7 to 40 mm in width, preferably 7 to 30 mm. When the width of the pulling flaps 1 is small, gripping becomes uncertain; and when the width is great, opening motion becomes unnecessarily large.

The seal section 2, located between the pulling flaps 1 and the roof section 4, seals opposite faces of the container, thereby sealing the container. An arbitrary known sealing compound, of either a heat-seal type or a solvent type, can be employed, so long as it does not hinder the opening method of the invention, and a sealing compound of a heat-seal type is preferably employed. For instance, a known sealing compound used for a milk carton or the like is preferable for a gable-top-type container.

<Automatic Opening for Solid Processing Agent Package>

Next, while a gable-top-type paper container is taken as an example, a typical example in which a solid processing agent package is attached to an automatic opening device or a development equipment, and a container of the package is opened, thereby discharging the solid processing agent, will be conceptually described by reference to a schematic drawing.

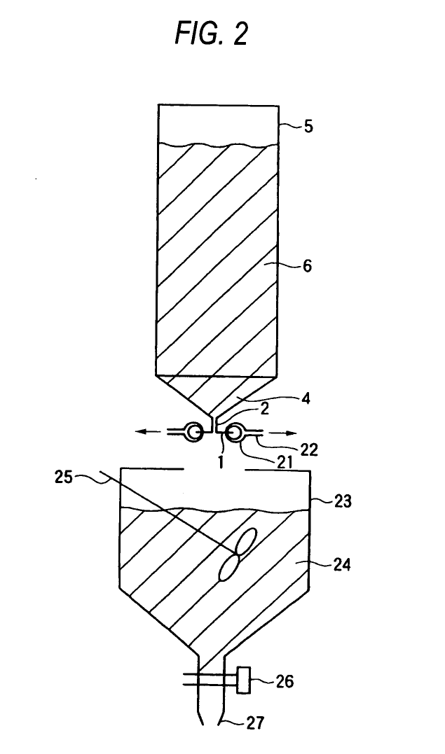

FIG. 2 is a schematic view showing a typical example in which a solid processing agent package is opened. FIG. 2 is a view for conceptually depicting a process where a package is opened and a solid processing agent housed therein is discharged from the container.

The main body 5 of the solid processing agent package is fixed on the opening device with the pulling flaps 1 on the bottom. A grip 21 is disposed at the tip of pulling means 22. A pair of grips 21 grip the respective pulling flaps 1. Subsequently, a pair of pulling means 22 moves in the directions indicated by arrows, whereby the pulling means 22, and accordingly the pulling flaps 1, and further the seal section 2, are pulled to thus peel off a seal. Consequently, a solid processing agent 6 is discharged from the container.

The thus-discharged solid processing agent is automatically dispensed in a dissolution bath 23 such as a processing solution preparation tank in the embodiment shown in FIG. 2, whereby a solution 24 such as a photographic-processing solution is prepared. The prepared solution is sent from a discharge port 27 to a replenishment tank, a processing tank, or the like in accordance with its purpose, by way of a discharge valve 26.

<Configuration of Container>

For a container of the package for solid processing agent, an arbitrary material, such as paper, plastic, or metal, may be used singly or in combination, so long as the material satisfies the aforementioned condition imposed on the surface resistivity of the inner surface or the material is a laminated material comprising a plurality of layers which contain a conductive aluminum metal thin layer. More particularly, the container is used as a container constructed of a single material, a laminated material consisting of a plurality of layers, or a material whose inner surface has been subjected to antistatic treatment.

A barrier packaging material is preferably employed as the material constituting the container, from the viewpoint of various types of stability. The material is selected from a sheet of paper having water-vapor barrier property and/or oxygen barrier property (e.g., resin impregnated paper, oil-based solvent impregnated paper, oil impregnated paper); plastic; laminated paper; a plastic/paper laminated material; a metal-foil/plastic laminated material; a film obtained by depositing aluminum, glass, or silica on a PET substrate; or a combination thereof, which can be formed into a prism-shaped package, and which has sufficient flexibility to allow pulling. Specific examples of a preferable material include a composite material having a structure of PE/paper/PE/aluminum foil/PET/PE/PEF, that having a structure of PE/paper/PE/aluminum foil/PET/PE, and that having a structure of PE/paper/PE/aluminum foil/PE.

In a case where the container is made of a single component material, the container is made from a material imparted with conductivity.

Examples of a preferred material include polyethylene kneaded with carbon black, paper containing a mixture of carbon black, salt-impregnated paper, polyethylene kneaded with aluminum powder, and polyethylene kneaded with polyether polymers.

In a case where a conductive film is caused to be formed on the inner surface of a container constituted of a single component material or a laminated material, conductivity is imparted thereto by means of atomization-coating or brush-coating the inner surface of the container with a surfactant; a conjugated double-bonding conductive polymer solution; a dispersion obtained by dispersing aluminum powders and other metals, or metallic compounds, in acrylate polymers; a dispersion obtained by dispersing carbon black in acrylate polymers; or the like.

In a case of a container constituted of a laminated material, the inner surface of the container must satisfy the aforementioned requirement for surface resistivity. To this end, the constituting layer forming the inner surface preferably has conductivity; however, conductivity is not requisite. For instance, in the composite material having a structure of PE/paper/PE/aluminum foil/PE (inner surface side), of which the aluminum layer is coated with an HDPE layer of 10 μm thickness, the requirement for conductivity may be satisfied without application of conductive coating, depending on the thickness of the PE layer of the inner surface side. This is considered attributable to contribution of conductivity of aluminum through the polyethylene layer.

In addition, the surface resistivity as referred to in the invention indicates a surface resistivity under the condition where the temperature is 25° C. and the humidity is 40% RH. The surface resistivity is determined according to the known method.

For the container for the use of the invention, a material having water-vapor permeability and oxygen permeability of 200 mL/m²·24 hrs·Pa or less, respectively, is preferable. Meanwhile, the oxygen permeability coefficient can be determined from a method described in “O₂ permeation of plastic container” (Modern Packing, N. J. Calyan, 1968, December) PP. 143 to 145. As a high-barrier packaging material, those described in “New Development of Functional Packaging Materials” (Toray Research Center, February, 1990) can be used.

The container having low oxygen permeability and low water-vapor permeability as disclosed in JP-A-63-17453, and the vacuum packaging materials disclosed in JP-A-4-19655 and JP-A-4-230748 can also be exemplified as suitable examples of the container material.

The inner surface of the container may be caused to maintain the specified surface resistivity by applying a conductive thin layer through treatment using a conductive coating solution or other method. However, as a component material of the container, there is preferably selected a material per se having the specified surface resistivity which does not require further surface treatment.

[Solid Processing Agent]

A solid processing agent housed in the solid processing agent package of the invention is a solid processing agent of arbitrary form selected from powder, granular, tablet, and the like. A preferred solid processing agent as an object to which the invention is applied is a solid photographic-processing agent. The solid processing agent may be of an arbitrary form selected from powder, granules, and tablets; and may be a single chemical or a mixed processing agent. Preferred forms are granular and tablet.

In addition to being applied to the powder processing agent of single constituent, powder agents are also applied to powder compositions formed by the following methods. Under one of the methods, respective constituents are pulverized by means of crushing, as required, so as to adjust grain sizes, or the like; and the respective powder raw materials are mixed in a prescribed ratio. Under another method, the respective constituents are dissolved in a solvent such as water, and thereafter pulverized by means of an appropriate drying method such as spray drying.

Under the latter method, for instance, a powder processing agent can be manufactured in accordance with a general method as described in JP-A-54-133332, British Patent No. 725892, British Patent No. 729862, German Patent No. 3733861, and the like.

For forming tablet agents, respective constituents are pulverized as required by means of crushing so as to adjust grain sizes, or the like; and the respective powder raw materials are mixed in a prescribed ratio. There may also be employed a method such that the respective constituents are dissolved in a solvent such as water, and thereafter pulverized by means of an appropriate drying method such as spray drying. If necessary, an appropriate binder is added for enhancing mechanical strength or stability of the tablet agents.

As a binder there may be employed, for instance, a water-soluble binder such as a polyvinyl alcohol, a methylcellulose, or a binder described in JP-5-333507 ([0066]).

The tablet processing agents can be manufactured, for instance, in accordance with a general method as described in JP-A-51-61837, JP-A-54-155038, JP-A-52-88025, British Patent No. 1213808, and the like. Tablets can also be manufactured in accordance with (2), (4), (5), or (6), particularly (2) and (4), of granulation methods described in “Granulation Handbook,” which will be described later, which are granulation methods for granular processing agents.

No particular limitation is imposed on a shape of a tablet, which maybe any of spherical, tabular, disc-like, indefinite, and the like. In addition, no limitation is imposed on the size of the tablet, so long as it allows easy handling; however, the longitudinal diameter is preferably 5 to 30 mm, more preferably 8 to 20 mm.

The granular processing agents can be manufactured, for instance, in accordance with a general method as described in JP-A-2-109042, JP-A-2-109043, JP-A-3-39735, JP-A-3-39739, JP-A-2001-183780, and the like.

In the invention, the term “spherical granules” refers to granules which are formed by granulating powder into a spherical shape. The spherical shape encompasses both a perfect sphere and an imperfect sphere, as well as granular shapes generally referred to as pellet, pill, and bead. In the invention, the mean diameter of the granules is preferably 0.5 to 20 mm, more preferably 1 to 15 mm, particularly preferably 2 to 10 mm. Effects of the invention are prominent when granules whose mean diameter is 0.5 mm or smaller account for 10 wt % or less of a granular solid processing agent, particularly preferably 0 to 5 wt %.

Preferred types of a granular solid processing agent include granules of a core-shell type and those having a multi-layered structure. When such a granular solid processing agent is employed, components which are less prone to consolidation or deliquescence can be disposed on a surface-coating layer, there by bringing about greater effects in attaining the object of the invention.

As a preparation method of a granular solid processing agent, there may be employed methods described in JP-A-2001-183780 and JP-A-2001-183779. More specifically, as a method of granulation, there maybe employed methods described in JP-A-2001-183779 ([0018] to [0027] and embodiments) and JP-A-2001-183780 ([0021] to [0028] and embodiments). As a processing agent container, there may be employed containers described in JP-A-2001-183779 ([0029] to [0033]) and JP-A-2001-183780 ([0030] to [0034]).

Granules can be formed in various shapes, such as spherical, cylindrical, prism-like, and indefinite. The mean diameter of the granules is preferably 0.1 to 10 mm, more preferably 0.2 to 8 mm, particularly preferably 0.3 to 5 mm.

Granules can be manufactured in accordance with any of a variety of known granulation methods, including manufacturing methods for granules of a core-shell type or a multi-layered structure. A variety of granulation methods applicable to the invention are described in “Granulation Handbook” (edited by The Association of Powder Process Industry and Engineering, Japan), and are also described in, e.g., JP-A-4-221951 and JP-A-2-109043, and the like.

Surfaces of the tablet or granular processing agents may be coated with water-soluble polymers for the purpose of protecting the surfaces and enhancing solubility. No particular restriction is imposed on the type of a water-soluble polymer used for coating, and one or more polymers selected from synthetic, semisynthetic, and natural water-soluble polymers can be used. Specific examples of such polymers include gelatin, pectin, polyacrylic acids, polyacrylates, polyvinyl alcohol, modified polyvinyl alcohol, polyvinyl pyrrolidone, polyvinyl pyrrolidone/vinyl acetate copolymer, polyethylene glycol, sodium carboxymethyl cellulose, hydroxypropylmethyl cellulose, hydroxyethyl cellulose, hydroxypropyl cellulose, methyl cellulose, ethyl cellulose, alginates, xanthangum, gumarabic, gumtragacanth, karaya gum, carrageenan, and methyl vinyl ether/maleic anhydride copolymer. Of these polymers, polyethylene glycol, polyvinyl pyrrolidone, hydroxypropyl cellulose, methyl cellulose, gum arabic, and carrageenan are preferably used, singly or in combination of two or more.

As a coating method for water-soluble polymers, a known method can be used without particular restrictions. However, the rolling, agitation, fluidized-bed, coating, fusion, or atomization-drying granulation process is preferably employed. A method of applying spray-coating on the surface of each granule with a 1 to 50% aqueous polymer solution, and drying the polymer is particularly preferable.

The solid processing agent according to the invention may be an arbitrary solid agent, such as a color developer, agents involved in a de-silvering process (a fixing agent, a bleaching agent, a bleach-fixing agent), and a rinsing agent.

In addition to the above, the solid processing agent is also applicable to a black-and-white developing agent, a reducer for use in photo engraving, a photographic-processing tank cleaning agent, and the like.

[Automatic Photographic-Processing Solution Preparation Device]

The most general application object of the opening device for a solid processing agent package used for a package of the invention is an automatic photographic processing solution preparation device. The automatic photographic processing solution preparation device—which is equipped with the automatic opening device—opens a solid processing agent package automatically, and dispenses the solid processing agent into a processing solution preparation tank, thereby preparing a processing solution. FIG. 2 shows an embodiment of the automatic photographic-processing solution preparation device. The main body 5 of the package which houses the solid processing agent 6 in the upper portion in FIG. 2 of the processing solution preparation tank 23 is opened by means such that the sealing section 2 is pulled by the grips 21 of the opening device. Accordingly, the solid processing agent 6 is discharged, mixed, and dissolved in the solution 24, whereby a processing solution such as a replenisher is prepared. According to the opening device, a solid processing agent can be rapidly discharged without dirtying the operator's hands, easily, and without leaving residues inside the container.

[Photosensitive Material Processing Device]

Another preferable object to which the opening device for a solid processing agent package is applied is a photosensitive material processing device, which is equipped with the automatic opening device, and which automatically opens a solid processing agent and dispenses the processing agent into a solid replenisher storage tank, whereby the solid processing agent is dispensed directly into a processing tank from the storage tank to thereby serve as a replenisher. In the photographic-processing device of this type, there is attained the same effect as attained in the case where water is added to the processing tank together with the solid processing agent and a stationary replenisher is replenished by means of mixing in the processing tank. For instance, in a photographic-processing device—which is disclosed in JP-A-2003-207825—f a type incorporating a solid processing agent storage tank, the opening device for the solid processing agent package of the invention can be mounted above the solid replenisher storage tank. Accordingly, a package of a solid processing agent is automatically opened and dispensed in the solid replenisher storage tank, whereby operability can be enhanced. More specifically, a preferred arrangement is such that the opening device for the solid processing agent package of the invention is disposed above a solid processing agent storage tank 100 shown in FIG. 5 in JP-A-2003-207825 so that the solid processing agent is dispensed into the storage tank 100 when the package is opened.

Additionally, still another preferable application object of the opening device of the invention is a photosensitive material processing device. The photosensitive material processing device—which includes the automatic opening device—automatically opens a solid processing agent, dispenses the solid processing agent into a replenisher preparation tank to prepare a replenisher, sends the thus-prepared replenisher to a replenishment tank, and performs replenishment from the replenishment tank to a processing tank.

### EXAMPLE

Specific examples of the present invention are shown below; however, the present invention is not limited thereto.

[Container]

The following four types of a solid processing agent container were used:

1) container of polyethylene kneaded with carbon black
shape: gusset type
thickness: 50 μm
capacity: 1 L (inner size of prismatic portion: 100×50 mm, height: 200 mm)
constituent material of the container: a film was formed by means of stretching a pellet of PE in which 10 wt % of activated carbon (Ketjen Black EC, manufactured by LION CORPORATION) had been kneaded.
surface resistivity of the inner surface of the container: 10⁵ Ω (relative humidity: 40% RH, temperature: 25° C.)
(Cf: surface resistivity of polyethylene without carbon black: 10¹⁶ Ω (relative humidity: 40% RH, temperature: 25° C.))

2) container of laminated film having a 2-layer structure consisting of PE/PET (the PE layer was on the inner surface side) with the surface thereof coated with conductive lacquer
shape: gusset type
thickness: PE 50 μm/PET 15.0 μm
capacity: 1 L (inner size of prismatic portion: 100×50 mm, height: 200 mm)
applied coating: Sb doped tinoxide-type antistatic coating ink (C-401, manufactured by Sumitomo Osaka Cement Co., Ltd)
coating thickness: 1.0 μm (in solid state)
surface resistivity: 10¹⁰ Ω (relative humidity: 40% RH, temperature: 25° C.)

3) container of laminated structure
shape: gable-top type
structure: LLDPE/PE/PET/Al/PE/paper/PE
layer thicknesses (in the order listed above): 50 μm, 15 μm, 15 μm, 6 μm, 15 μm, (base paper), 12 μm
base paper: LBKP having a basis weight of 337 μg/m²
capacity: 1 L (inner size of prismatic portion: 85×85 mm, height: 140 mm)
surface resistivity: 3×10¹⁵ Ω (relative humidity: 40% RH, temperature: 25° C.)

4) comparative example container: made of single material of polyethylene
shape: gusset type
formation: HDPE
thickness of prismatic portion: 50 μm
capacity: 1 L (inner size of prismatic portion: 100×50 mm, height: 200 mm)
surface resistivity: 10¹⁶ Ω (relative humidity: 40% RH, temperature: 25° C.)
   [Solid Processing Agents]

The following two types of solid processing agent were used.

A) The granular color developer of test number 5 in Table 1 in Example 1 of JP-A-2001-183779 was prepared in accordance with the descriptions of the embodiments in the specification.

B) The granular bleach-fixing agent of test number 6 in Table 3 in Example 3 of JP-A-2001-183779 was prepared in accordance with the descriptions of the embodiments in the specification.

[Testing Method]

The respective containers, which were filled with the solid processing agent A or B, were subjected to heat sealing with use of a commercially-available heat-hardening adhesive with a sealing pressure of 1 t under 370° C., to thereby prepare solid processing agent packages.

The solid processing agent packages were left at 10° C. and 10% relative humidity for 10 days for conditioning. Thereafter, the following test was carried out.

Under the above-mentioned environmental conditions, the solid processing agent packages were subjected to reciprocation in the vertical direction (maximum acceleration 2 G) with an amplitude of 20 cm for 10 cycles so as to generate static electricity. This is an operation to adapt the packages to rigorous handling conditions as in transportation or bundling of the packages.

After the reciprocation, the container was immediately opened to thus discharge the solid processing agent. Thereafter, electrostatic charge of the discharged processing agent was measured three times continuously with use of a Faraday gauge. In addition, the weight of the processing agent remaining in the container was measured.

The results are shown in Table 1. Table 1 shows all the measured values for the three repetitions (n=3).

TABLE 1

| | | | | Residual | |
|---|---|---|---|---|---|
| | surface | | | chemicals | |
| | resist- | electrostatic | | after | |
| | ivity of | charge | | discharge | |
| | container | [coulomb] | | [g] | |
| | [Ω] | P1R | P2R | P1R | P2R |
| 1) container of | 4*10⁵ | 1.2*10⁻⁹ | 7.0*10⁻⁹ | 0.00 | 0.00 |
| polyethylene kneaded | | | | | |
| with carbon black | | | | | |
| 1) container of | | 1.2*10⁻⁹ | 7.0*10⁻⁹ | 0.00 | 0.00 |
| polyethylene kneaded | | | | | |
| with carbon black | | | | | |
| 1) container of | | 1.2*10⁻⁹ | 7.0*10⁻⁹ | 0.00 | 0.00 |
| polyethylene kneaded | | | | | |
| with carbon black | | | | | |
| 2) container of 2-layer | 8*10¹⁰ | 8.0*10⁻⁸ | 1.2*10⁻⁷ | 0.04 | 0.10 |
| film coated with | | | | | |
| lacquer-type | | | | | |
| conductive surface | | | | | |
| coating material | | | | | |
| 2) container of 2-layer | | 8.5*10⁻⁸ | 1.5*10⁻⁷ | 0.03 | 0.11 |
| film coated with | | | | | |
| lacquer-type | | | | | |
| conductive surface | | | | | |
| coating material | | | | | |
| 2) container of 2-layer | | 5.0*10⁻⁸ | 1.0*10⁻⁷ | 0.04 | 0.09 |
| film coated with | | | | | |
| lacquer-type | | | | | |
| conductive surface | | | | | |
| coating material | | | | | |
| 3) container of | 3*10¹⁵ | 1.4*10⁻⁷ | 2.0*10⁻⁷ | 0.05 | 0.10 |
| multi-layer paper of | | | | | |
| LLDPE/PE/PET/Al | | | | | |
| foil/PE/paper/PE | | | | | |
| 3) container of | | 1.4*10⁻⁷ | 2.2*10⁻⁷ | 0.06 | 0.12 |
| multi-layer paper of | | | | | |
| LLDPE/PE/PET/Al | | | | | |
| foil/PE/paper/PE | | | | | |
| 3) container of | | 1.2*10⁻⁷ | 2.7*10⁻⁷ | 0.04 | 0.09 |
| multi-layer paper of | | | | | |
| LLDPE/PE/PET/Al | | | | | |
| foil/PE/paper/PE | | | | | |
| 4) container of | 5*10¹⁶ | 9.0*10⁻⁷ | 1.2*10⁻⁶ | 5.00 | 2.00 |
| polyethylene film | | | | | |
| 4) container of | | 1.2*10⁻⁶ | 1.1*10⁻⁶ | 5.10 | 1.95 |
| polyethylene film | | | | | |
| 4) container of | | 1.1*10⁻⁶ | 1.2*10⁻⁶ | 4.98 | 1.98 |
| polyethylene film | | | | | |

Table 1 shows that measurement values of the three repetitions are good in reproduction, and that, in every measurement, electrostatic charge of the comparative container 4), is higher than any of electrostatic charge of containers 1) and 2) whose inner surface has low surface resistivity and electrostatic charge of container 3) whose inner surface has high surface resistivity but which is made of material containing Al foil layer in the construction layer according to the invention. Accordingly, the results reveal that when the surface resistivity of the inner surface of the container is high or the material of the container does not have a conductive metal layer such as Al foil, electrostatic charge is large, and residues of the solid processing agent are increased in amount.

The present invention is not limited to the specific above-described embodiments. It is contemplated that numerous modifications may be made to the present invention without departing from the spirit and scope of the invention as defined in the following claims.

This application is based on Japanese Patent application JP2004-065343, filed Mar. 9, 2004, the entire content of which is hereby incorporated by reference. This claim for priority benefit is being filed concurrently with the filing of this application.

1. A package for a solid photographic-processing agent, wherein the package is a prism-like container having an opening section at a top, and an inner surface of the container has resistivity of 10¹² Ω or less.

2. The package according to claim 1, wherein the container is a single component material having a surface resistivity of 10¹² Ω or less.

3. The package according to claim 1, wherein the container is a laminated material and an inner surface of the container has a surface resistivity of 10¹² Ω or less.

4. The package according to claim 1, wherein the inner surface has been treated with an antistatic agent.

5. The package according to claim 1, wherein the prism-like container is a gable-top-type paper packaging material.

6. The package according to claim 1, wherein the prism-like container is a gusset pouch-type film packaging material.

7. A package for a solid photographic-processing agent, wherein the package is a prism-like container having an opening section at a top, and a material of the container is a laminated material comprising a plurality of layers which contain at least a conductive aluminum metal thin layer.

8. The package according to claim 7, wherein an inner surface of the container has been treated with an antistatic agent.
